(19) United States
(12) Patent Application Publication
(10) Pub. No.: US 2012/0288002 A1
(43) Pub. Date: Nov. 15, 2012

(54) METHOD AND APPARATUS FOR COMPRESSING VIDEO USING TEMPLATE MATCHING AND MOTION PREDICTION

(75) Inventors: Il Hong SHIN, Daejeon (KR); Jung Won KANG, Seoul (KR); Jin Woo CHOI, Daejeon (KR); Sang Taick PARK, Seoul (KR); Won RYU, Daejeon (KR)

(73) Assignee: Electronics and Telecommunications Research Institute, Daejeon (KR)

(21) Appl. No.: 13/291,568

(22) Filed: Nov. 8, 2011

(30) Foreign Application Priority Data
Nov. 8, 2010 (KR) 10-2010-0110322

(51) Int. Cl. H04N 7/32

(52) U.S. Cl. 375/240.16; 375/240.12; 375/E07.104; 375/E07.243

(57) ABSTRACT

Provided is an apparatus and method for motion estimation using a template that is generated by applying an intra-prediction. A template including intra-prediction information of a current block may be generated, and an optimal predicted range may be retrieved by performing a template matching using the template.

### FIELD OF THE INVENTION

Exemplary embodiments relate to a method and apparatus for generating a template that is used for coding and encoding a video.

### BACKGROUND ART

A video compression scheme using a hybrid encoding scheme may utilize a spatial redundancy using the discrete cosine transform (DCT), and eliminate a temporal redundancy using a motion estimation (ME)/motion compensation (MC), thereby enhancing efficiency of coding.

An H.264 video compression scheme may correspond to video coding scheme having a relatively high efficiency, and may use a new video codec having an enhanced compressibility. Accordingly, a standardization and idea of a high efficiency video coding (HEVC) may be verified.

### DESCRIPTION OF THE INVENTION

### Subjects to be Solved

Exemplary embodiments of the present invention may provide a method of generating a template using a directionality of an adjacent block, and a template generated using the method.

Exemplary embodiments of the present invention may provide an apparatus and method for estimating a motion using a template that is generated by applying an intra-prediction.

### Means for Resolving Subjects

According to an aspect of the present invention, there is provided a template used for a video decoding, the template including an adjacent block template including at least one decoded block, adjacent to a current block to be decoded, in a decoded area in a current frame, and a predicted block template generated based on a predicted location, wherein the predicted location is generated by applying an intra-prediction to the at least one decoded block.

A size of the adjacent block may be changed depending on a size of the current block.

A directionality of the intra-prediction may be limited based on a size of the current block.

The intra-prediction may have nine directionalities when the size of the current block is less than or equal to a predetermined size, and the intra-prediction may have four directionalities when the size of the current block is greater than the predetermined size.

A directionality of the intra-prediction may be limited based on a shape of the current block.

The directionality of the intra-prediction may be limited based on whether the current block corresponds to a square shape or a rectangular shape.

Directionality information of the at least one decoded block may be included in a bit stream that has the current frame.

According to another aspect of the present invention, there is provided an apparatus for motion estimation used for video decoding, the apparatus including a template generator to generate a template including directionality prediction information of a current block to be decoded, and an optimal location retrieving unit to retrieve an optimal location of a predicted block by performing a template matching between the generated template and a previously decoded frame, wherein the template matching uses the directionality prediction information.

The template may include an adjacent block template including at least one decoded block, adjacent to the current block, in a decoded area in a current frame, and a predicted block template generated based on a predicted location, and the predicted location may be generated by applying an intra-prediction to the at least one decoded block.

The template matching may correspond to a weighted sum of a template matching using the adjacent block template and a template matching using the predicted block template.

A weight used for the weighted sum is included in syntax information of the current frame, and is transmitted.

The template matching may be performed based on at least one of a sum of absolute difference (SAD) or a sum of squared difference (SSD).

The syntax information of the current frame may include information indicating whether to use the SAD or the SSD to perform the template matching.

According to still another aspect of the present invention, there is provided a method for motion estimation used for a video decoding, the method including decoding a first frame, decoding a first block of a second frame, generating a template based on the first block and a second block that is generated by applying an intra-prediction to the first block, determining a third block based on a template matching between the template and the first frame, and decoding a fourth block of the second frame based on the third block.

The template may include a first template part generated based on the first block and a second template part generated by applying an intra-prediction to the first block.

The template matching may correspond to a weighted sum of a template matching using the first template part and a template matching using the second template part.

The first frame may correspond to a frame preceding the second frame, temporally, in the corresponding video.

The template matching may use at least one of an SAD or an SSD.

### Advantageous Effects of the Invention

According to exemplary embodiments of the present invention, it is possible to provide a method of generating a template using a directionality of an adjacent block, and a template generated using the method.

According to exemplary embodiments of the present invention, it is possible to provide an apparatus and method for estimating a motion using a template that is generated by applying an intra-prediction.

### BRIEF DESCRIPTION OF THE DRAWING

FIG. 1 is a diagram of an H.264 video encoder according to exemplary embodiments of the present invention.

FIG. 2 illustrates a block configuration of a 4×4 intra-prediction according to exemplary embodiments of the present invention.

FIG. 3 illustrates directions of a 4×4 intra-prediction according to exemplary embodiments of the present invention.

FIG. 4 illustrates 4×4 intra-prediction modes according to exemplary embodiments of the present invention.

FIG. 5 illustrates 16×16 intra-prediction modes according to exemplary embodiments of the present invention.

FIG. 6 illustrates a template matching scheme according to exemplary embodiments of the present invention.

FIG. 7 illustrates a configuration of a motion estimation (ME)/motion compensation (MC) encoder based on a template according to exemplary embodiments of the present invention.

FIG. 8 illustrates a configuration of a template using an intra-prediction and a method of generating the template according to exemplary embodiments of the present invention.

FIG. 9 illustrates a template matching using a template using an intra-prediction according to exemplary embodiments of the present invention.

FIG. 10 illustrates a configuration of an apparatus for motion estimation according to exemplary embodiments of the present invention.

FIG. 11 illustrates a flowchart of a method for motion estimation of a video decoding according to exemplary embodiments of the present invention.

### DETAILED EXPLANATION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

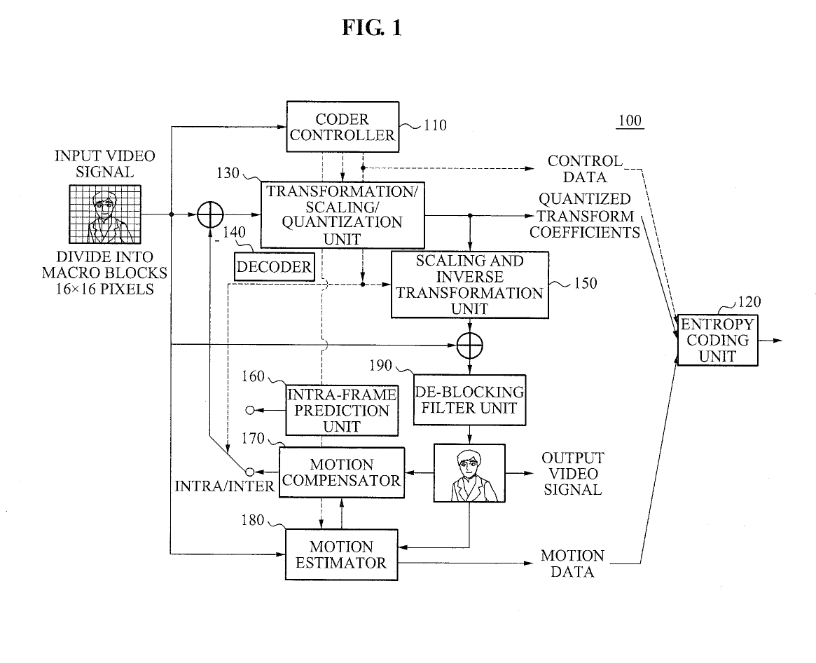

FIG. 1 is a diagram of an H.264 video encoder according to exemplary embodiments of the present invention.

An H.264 video encoder 100 may use a hybrid encoding scheme of a temporal prediction and spatial prediction combined with a transform coding. The H.264 video encoder 100 may use a combination of several technologies such as the discrete cosine transform (DCT), a motion estimation (ME)/motion compensation (MC), an intra-prediction, a loop-filter, and the like.

The H.264 video encoder 100 illustrates a video coding layer for a macro block.

A figure illustrated by an input video signal may be divided into blocks. In general, a first figure or a random access point of a sequence may be intra-coded. That is, the first figure or the random access point may be coded by using information included in the figure, exclusively.

Each sample of a block in an intra-frame may be predicted using samples of previously coded blocks that are spatially neighboring.

An encoding process may select a scheme of using neighboring samples for the intra-prediction. The selection may be conducted simultaneously in an encoder and a decoder using transmitted intra-prediction side information.

In general, an “inter” coding may be used for any figures remaining between random access points or for any remaining figures of all sequences. The inter-coding may employ a prediction (MC) from other previously decoded figures. An encoding process (ME) for an inter-prediction may include a selection of motion data, a composition of a figure, and a spatial displacement applied to all samples of a block. The motion data transmitted as side information may be used by the encoder or the decoder to provide an inter-prediction signal concurrently.

A residual of one of the intra-prediction and the inter-prediction, which corresponds to a difference between an original block and a predicted block, may be transformed. Here, transform coefficients may be scaled and quantized. That is, quantized transform coefficients may be entropy-coded, and may be transmitted along with the side information for an intra-frame or inter-frame prediction.

The encoder may include the decoder to perform a prediction for subsequent blocks or subsequent figures. Thus, the quantized transform coefficients may be inverse-scaled and inverse-transformed in the same scheme as that on a decoder side, thereby resulting in a decoded predicted residual. The decoded predicted residual may be added to a prediction. A result of the addition may be fed to a de-blocking filter that provides a decoded video as an output.

The H.264 video encoder 100 may include a coder controller 110, an entropy coding unit 120, a transformation/scaling/quantization unit 130, a decoder 140, a scaling and inverse transformation unit 150, an intra-frame prediction unit 160, a motion compensator 170, a motion estimator 180, and a de-blocking filter unit 190.

The coder controller 110 may control the entropy coding unit 120 by generating control data according to an input video signal.

The entropy coding unit 120 may perform entropy coding.

The transformation/scaling/quantization unit 130 may perform a transformation, scaling, and quantization.

The decoder 140 may correspond to the decoder described in the foregoing.

The scaling and inverse transformation unit 150 may perform scaling and an inverse-transformation.

The intra-frame prediction unit 160 may perform intra-frame prediction.

The motion compensator 170 may perform the MC.

The motion estimator 180 may perform the ME.

A control of a coder, entropy coding, a transformation, scaling, quantization, decoding, an inverse-transformation, intra-frame prediction, the MC, and the ME described in the foregoing will be further described with reference to exemplary embodiments of the present invention.

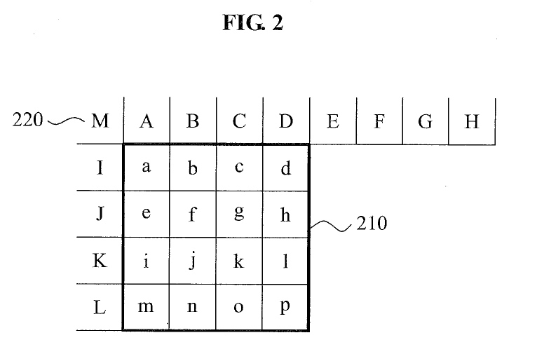

FIG. 2 illustrates a block configuration of a 4×4 intra-prediction according to exemplary embodiments of the present invention.

In response to an intra 4×4 mode being used, each 4×4 block, for example, a 4×4 block 210 may be predicted from samples that are spatially neighboring.

That is, using previously decoded images at an upper side, a left side, an upper left side, and an upper right side of the 4×4 block 210, a directionality of a current block may be determined, and the determined directionality may be used for compression of the current block.

Sixteen samples of the 4×4 block 210 labeled “a” through “p” may be predicted using previously decoded samples in adjacent blocks 220 labeled “A” through “P.”

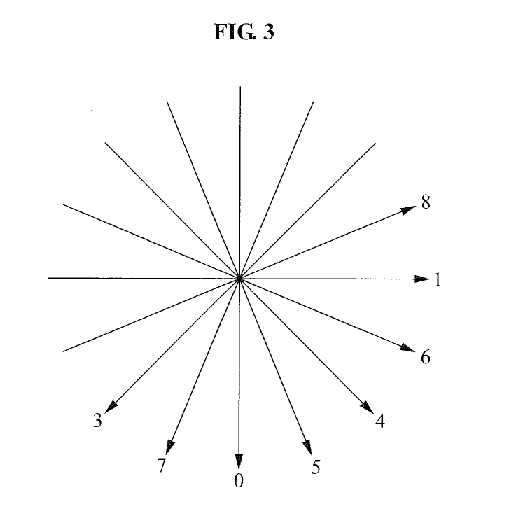

FIG. 3 illustrates directions of a 4×4 intra-prediction according to exemplary embodiments of the present invention.

FIG. 3 illustrates nine directionality prediction modes.

For each block of the 4×4 blocks, one of nine directionality modes may be used. A mode such as the nine directionality modes may be suitable for predicting directional structures in a figure such as edges at various angles.

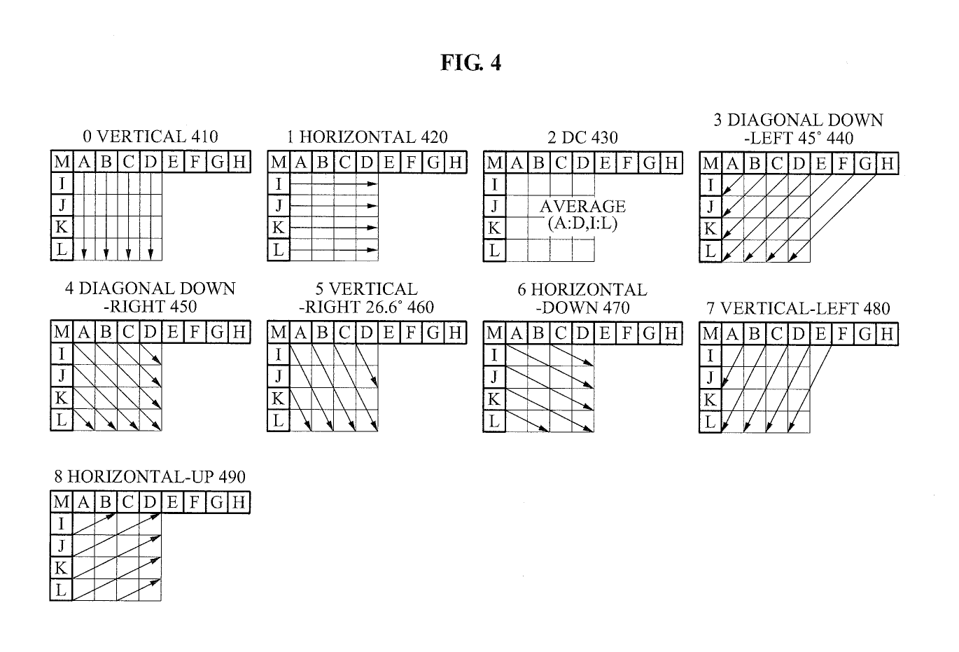

FIG. 4 illustrates 4×4 intra-prediction modes according to exemplary embodiments of the present invention.

FIG. 4 illustrates nine prediction modes corresponding to a mode (0) 410 through a mode (8) 490.

In the mode (0) 410 corresponding to a vertical prediction, samples above 4×4 blocks may be copied to blocks as illustrated by arrows. The mode (1) 420 corresponding to a horizontal prediction may be similar to the vertical prediction except left samples of the 4×4 blocks being copied. In the mode (2) 430 corresponding to a DC prediction, adjacent samples may be averaged as illustrated in FIG. 4. Six remaining modes 440 through 490 may correspond to diagonal prediction modes. The diagonal prediction modes corresponding to the modes (3) 440 through (8) 490 may be referred to as a diagonal down-left prediction, a diagonal down-right prediction, a vertical-right prediction, a horizontal-down prediction, a vertical-left prediction, and a horizontal-up prediction, respectively.

As can be understood from names of the prediction modes, a mode may be adapted to predict a texture having structures in a predetermined direction.

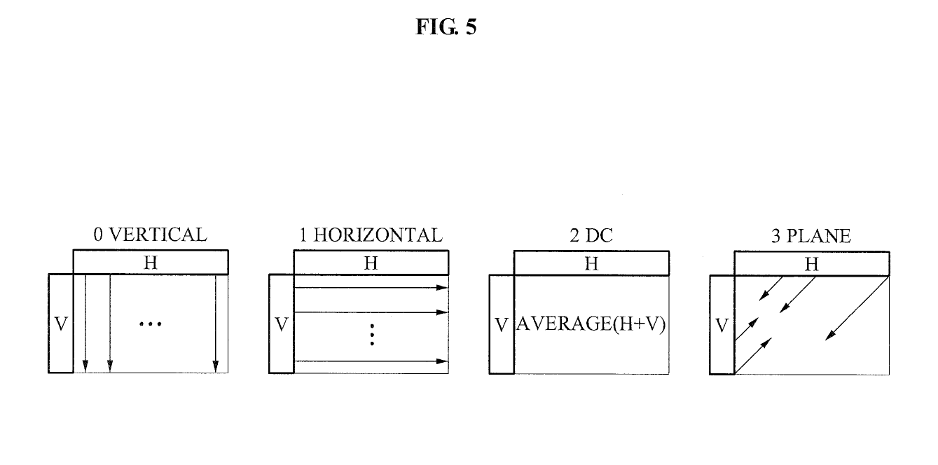

FIG. 5 illustrates 16×16 intra-prediction modes according to exemplary embodiments of the present invention.

The 16×16 intra-prediction modes may use a previously decoded adjacent block, and may use four directionalities.

A mode (0) 510 corresponding to a vertical prediction, a mode (1) 520 corresponding to a horizontal prediction, a mode (2) 530 corresponding to a DC prediction, and a mode (3) 540 corresponding to a plane prediction are illustrated.

The plane prediction may correspond to a position-specific linear combination prediction, and may be favorable for a slowly varying area.

According to the intra-prediction described with reference to FIG. 2 through FIG. 5 in the foregoing, a directionality of a current block may be predicted using information about a previously encoded and decoded block adjacent to a block currently to be encoded and decoded (hereinafter, referred to as a current block). Using optimal directionality information, a predicted block of the current block may be acquired. The predicted block may be extracted from an original block, and the extracted predicted block may be encoded through the DCT and a quantization process.

The intra-prediction described with reference to FIG. 2 through FIG. 5 in the foregoing may be used in the H.264 video encoding scheme.

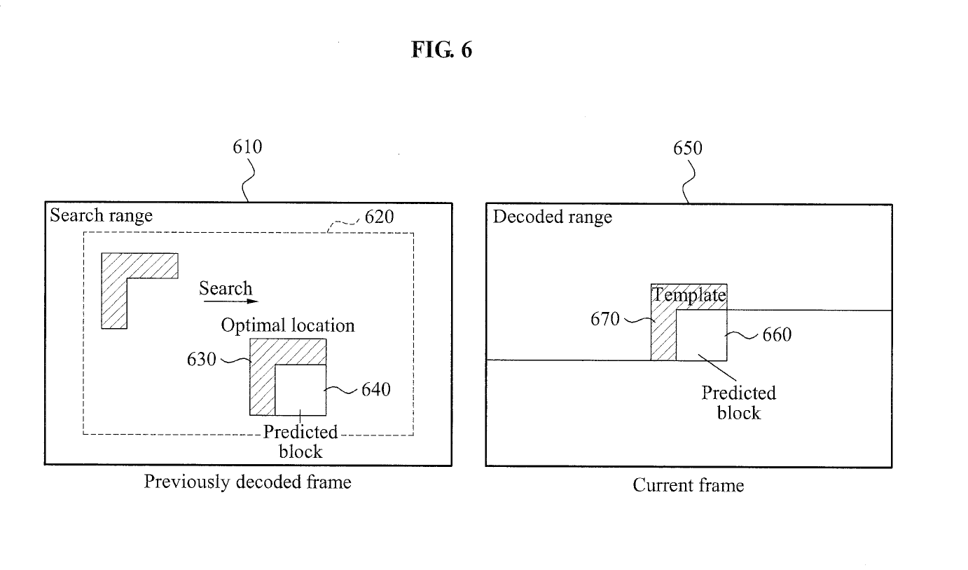

FIG. 6 illustrates a template matching scheme according to exemplary embodiments of the present invention.

A template based an ME/MC may generate, as a template, previously coded/decoded video information adjacent (that is, up, left, up-left, and up-right) to a current block that is currently to be coded, and may perform the ME/MC in a reference frame using the generated template.

In a current frame 650 corresponding to a currently decoded frame, a range decoded before a current block 660 (or a portion of a decoded range) may include a template 670.

In response to the template 670 being included, a predetermined range in a previously decoded frame 610 may be set to a search range 620. An ME may be performed in the set search range 620.

In an optimal location 630, a predicted block 640 corresponding to the current block 660 may be acquired. The acquired predicted block 640 may be used for predicting the current block 660.

When a coder and a decoder perform the same process described in the foregoing, the decoder may find an optimal predicted range. Thus, unlike a conventional video codec, a motion vector may not be transmitted to the decoder. The motion vector may not be transmitted during a coding, and compression (or coding) efficiency may be enhanced.

However, the process may entail an increased amount of calculation by the decoder since the decoder may perform the ME/MC. Further, the generated template may not include a current block (that is, the current block may not be decoded). Thus, use of the template may decrease.

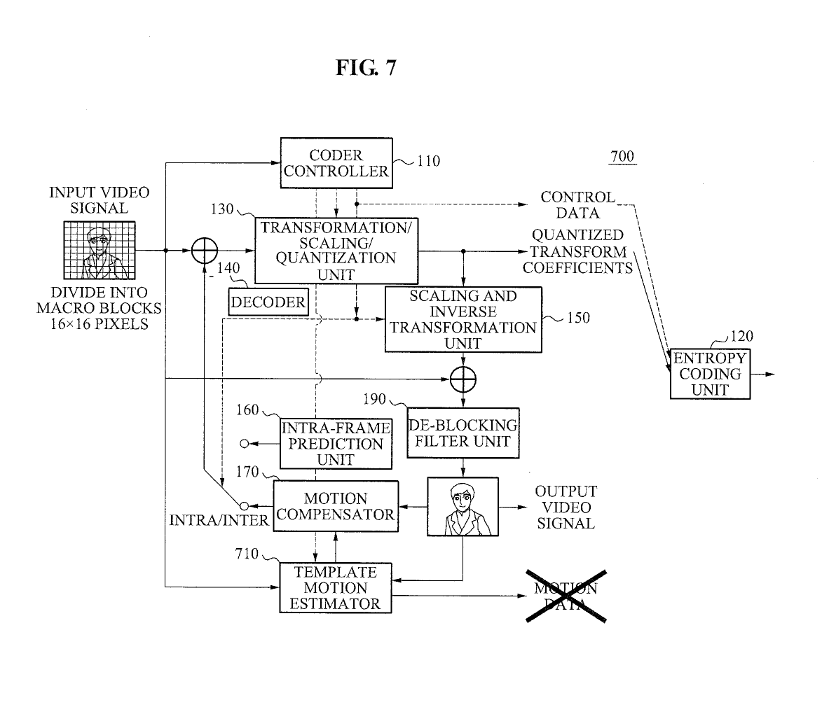

FIG. 7 illustrates a configuration of an ME/MC encoder based on a template according to exemplary embodiments of the present invention.

A template based encoder 700 may include a coder controller 110, an entropy coding unit 120, a transformation/scaling/quantization unit 130, a decoder 140, a scaling and inverse transformation unit 150, an intra-frame prediction unit 160, a motion compensator 170, and a de-blocking filter unit 190 of the H.264 video encoder 100 described in the foregoing. Descriptions of the components corresponding to 110, 120, 130, 140, 150, 160, 170, and 190 will be omitted for conciseness.

The template based encoder 700 may include a template motion estimator 710 instead of the motion estimator 180.

The template motion estimator 710 may perform an ME based on a template matching scheme described with reference to FIG. 2 through FIG. 6.

The template motion estimator 710 may retrieve an optimal location by calculating a value of sum of absolute difference (SAD) using Equation 1.

$$SAD ( vy , vx ) = {\sum }_{i , j ∈ {R}^{T}} \vert R ( i + vy , j + vx ) - T ( i , j ) \vert \qquad [ Equation 1 ]$$

vy and vx denote motion vectors. R denotes pixel information of a reference frame (that is, the previously decoded frame 610), and T denotes pixel information of the template 670 included according to the current block 660.

That is, using Equation 1, the value of SAD between the previously decoded frame 610 and the template 670 defined as R^{T} may be calculated. Using the value of SAD calculated, a motion vector having a minimal SAD value in the determined search range 620 may be obtained (that is, calculated). Using the motion vector, a location of a template may be calculated, and a predicted block 640 may be obtained.

Equation 1 may exclude information about the current block 660 of the current frame 650. Thus, a prediction performance of a template based encoding used in exemplary embodiments of the present invention may be limited.

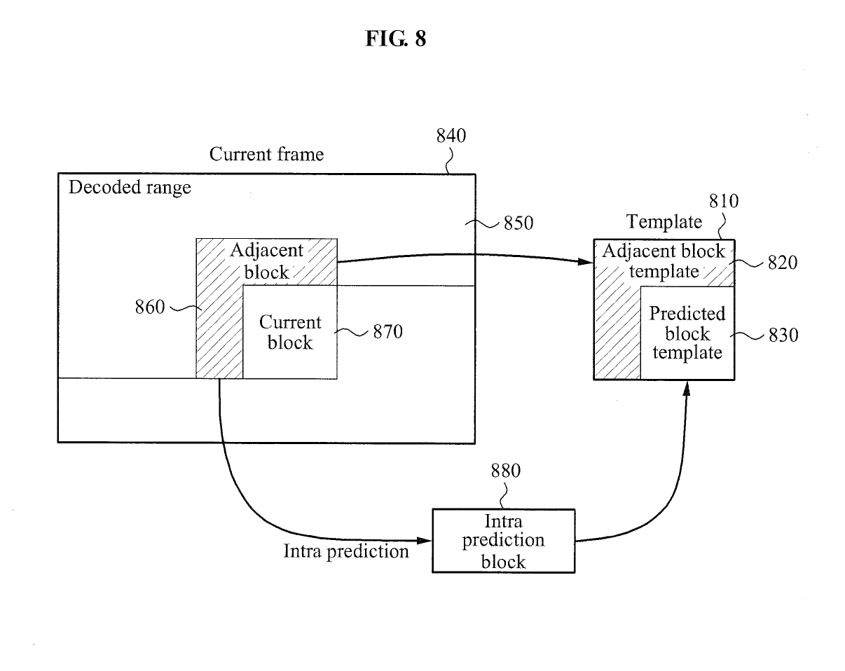

FIG. 8 illustrates a configuration of a template using an intra-prediction and a method of generating the template according to exemplary embodiments of the present invention.

A template 810 using an intra-prediction may include an adjacent block template 820 and a predicted block template 830. In general, the template 810 using an intra-prediction may include the adjacent block template 820 and the predicted block template 830. As illustrated, the template 810 may be provided in a rectangular shape. The predicted block template 830 may be provided in a rectangular shape located at a corner such as a bottom-right side of the template 810. The adjacent block template 820 may be provided in a shape of a portion excluding the predicted block template 830 from the template 810.

In a current frame 840, a current block 870 to be decoded and a decoded range (which may be referred to as an adjacent block 860) are illustrated.

The adjacent block 860 may correspond to at least one decoded block adjacent (that is, up, left, up-left, and up-right) to the current block 870 in a decoded range 850 of the current frame 840.

The adjacent block template 820 may correspond to the adjacent block 860. That is, the adjacent block template 820 may correspond to the template 670 illustrated in FIG. 6.

As illustrated, a combination of the adjacent block 860 and the current block 870 may correspond to a rectangular shape. The current block 870 may be provided in a rectangular shape located at a corner such as a bottom-right side of the combination. The adjacent block 820 may be provided in a shape corresponding to a portion excluding the current block 870 from the combination.

An intra-predicted block 880 may be generated by applying an intra-prediction to the adjacent block 860. That is, an optimal predicted location may be retrieved by applying an intra-prediction as used in, for example, the H.264 video encoding scheme to the adjacent block 860. In this instance, the intra-predicted block 880 may be generated based on the retrieved predicted location.

The predicted block template 830 may correspond to the intra-predicted block 880.

That is, the template 810 using an intra-prediction may be considered to include the adjacent block 860 and the intra-predicted block 880.

The current block 870 may have various sizes. Here, a size of a decoded block or the adjacent block 860 may vary depending on a size of the current block 870.

A directionality of an intra-prediction may be limited based on a size of the current block 870.

For example, the intra-prediction may have nine directionalities when the current block 870 is less than or equal to 8×8 as described with reference to FIG. 4, and may have four directionalities when the current block 870 is greater than 8×8.

A directionality of an intra-prediction may be limited based on a shape of the current block 870.

For example, a predicted block may be predicted with four directionalities when the current block 800 is provided in a rectangular shape such as 4×8 or 8×4 rather than a square such as 4×4, 8×8, and 16×16.

Directionality information of each block may be entropy coded, and may be transmitted in a bit stream including a current frame. In this instance, entropy coding may involve a scheme such as the intra-prediction of H.264.

The template 810 using an intra-prediction may correspond to a directionality prediction through an intra-prediction, and may make up for a case in which a template excludes information about a current block.

The template 810 using an intra-prediction may include directionality prediction information of a current block. Thus, an accuracy of a template matching may be enhanced using the template 810 using an intra-prediction.

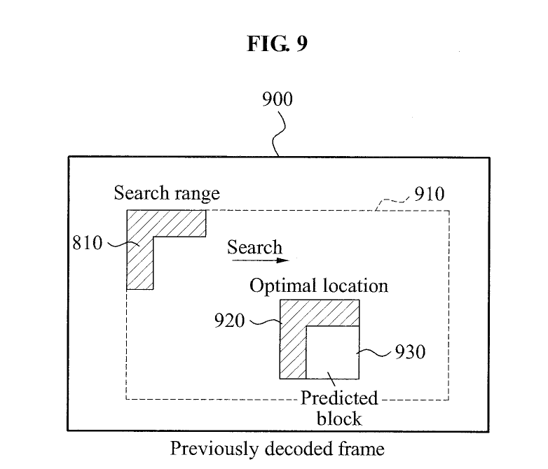

FIG. 9 illustrates a template matching using a template using an intra-prediction according to exemplary embodiments of the present invention.

In response to the template 810 using an intra-prediction being included, a predetermined range in a previously decoded frame 900 may be set to a search range 910. An ME may be performed in the set search range 910. An optimal location 920 may be retrieved by the ME.

A predicted block 930 corresponding to the current block 870 may be acquired from the optimal location 920. The acquired predicted block 930 may be used for predicting the current block 870.

A template matching may be performed by use of Equation 2.

The template matching according to Equation 2 may include calculating a template sum of absolute difference (TSAD) using directionality prediction information.

$$TSAD ( vy , vx ) = w \times {\sum }_{i , j ∈ {R}^{T}} {\vert R ( i + vy , j + vx ) - T ( i , j ) \vert}^{n} + ( 1 - w ) \times {\sum }_{k , l ∈ {R}^{IP}} {\vert R ( k + vy , l + vx ) - IP ( k , l ) \vert}^{n} \qquad [ Equation 2 ]$$

vy and vx denote motion vectors.

T denotes an area of the adjacent block template 820 (that is, an area excluding the current block 870) in the template 810 using an intra-prediction.

IP denotes an area of the predicted block template 830 (that is, an area of the current block 870) in the template 810 using an intra-prediction.

w corresponds to a weight value. In response to a value of w being “1,” a template matching (ME) using the adjacent block template 820 may be performed, and in response to a value of w being “0,” a template matching (ME) using the predicted block template 830 may be performed.

w may adjust an importance in the template matching of the adjacent block template 20 and the predicted block template 830. That is, the template matching may correspond to a weighted sum of a template matching using the adjacent block template 820 and a template matching using the predicted block template 830. In this instance, the corresponding weight may be adjusted by the value of w.

A value of w may be included in syntax information of a stream during encoding (or compression).

The template matching may be performed based on an SSD as well as an SAD.

As shown in Equation 2, the SAD may be used for the template matching when n equals 1, and the SSD may be used for the template matching when n equals 2.

A value of n may be included in the syntax information of the stream during encoding (or compression).

A minimum value of the TSAD may be calculated in the search range 910 using Equation 2. A motion vector (vy, vx) corresponding to the minimum value of the TSAD may be estimated.

An IP area corresponding to a value of the TSAD may be determined by a motion vector, and the predicted block 930 may be retrieved in the decoded frame 900 by the determined IP area.

In general, in a video compression, an inter-frame (inter-screen) prediction and an intra-frame (in-screen) prediction may be used, individually. In exemplary embodiments of the present invention, an intra-inter frame prediction scheme in which an intra-prediction is used for a template matching is disclosed. Exemplary embodiments of the present invention may enhance compression efficiency by combining intra-frame information and inter-frame information.

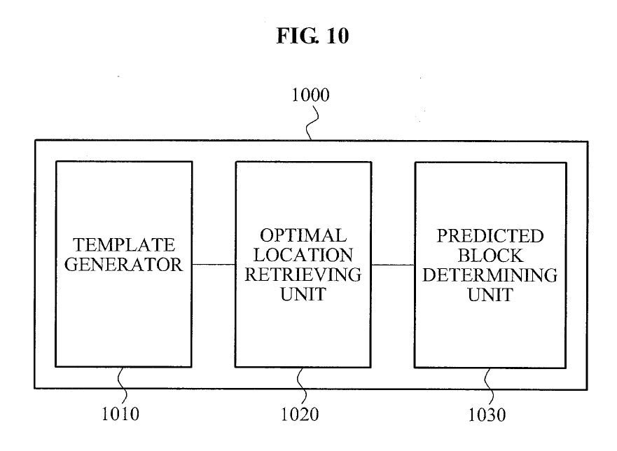

FIG. 10 illustrates a configuration of an apparatus for motion estimation according to exemplary embodiments of the present invention.

An apparatus for motion estimation 1000 may include a template generator 1010 and an optimal location retrieving unit 1020, and may further include a predicted block determining unit 1030.

The template generator 1010 may generate the template 810 including directionality prediction information of the current block 870 to be decoded.

The optimal location retrieving unit may retrieve an optimal location of the predicted block 930 by performing a template matching between the generated template 810 and the previously decoded frame 900. The template matching may correspond to the template matching described in the foregoing with reference to FIG. 9.

The predicted block determining unit 1030 may determine the predicted block 930 in the previously decoded frame 900 according to the retrieved optimal location.

Technical descriptions according to exemplary embodiments of the present invention described with reference to FIG. 1 through FIG. 9 may be applied to the present exemplary embodiment. Thus, further descriptions will be omitted for conciseness.

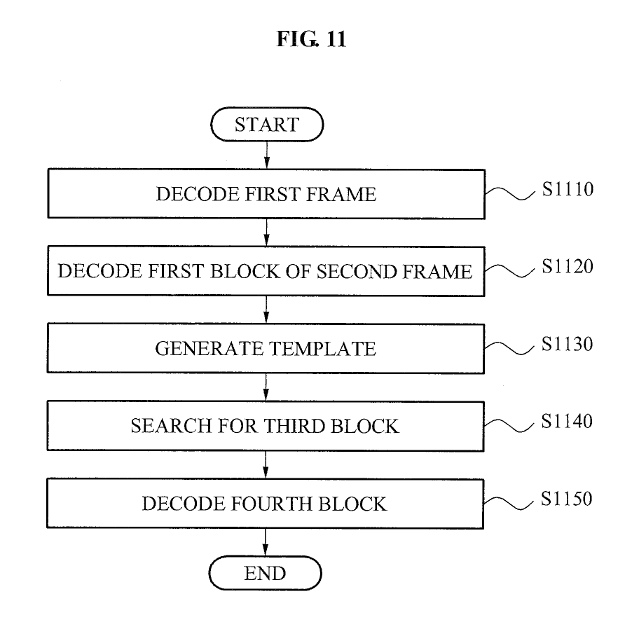

FIG. 11 illustrates a flowchart of a method for motion estimation of a video decoding according to exemplary embodiments of the present invention.

In operation S1110, a first frame is decoded. The first frame may correspond to the previously decoded frame 900.

In operation S1120, a first block of a second frame may be decoded. The second frame may correspond to the current frame 840. The first block may correspond to at least one of blocks included in adjacent blocks.

The first frame and the second frame may correspond to frames of a video stream. The first frame may correspond to a frame preceding the second frame, temporally.

In operation S1130, a template may be generated based on the first block and a second block that is generated by applying an intra-prediction to the first block. The second block may correspond to the intra-predicted block 880. The template may correspond to the template 810 using an intra-prediction.

For example, the template may include a first template part generated based on the first block and a second template part generated by applying an intra-prediction to the first block. The first template part may correspond to the adjacent block template 810, and the second template part may correspond to the predicted block template 830.

In operation S1140, a third block may be determined based on template matching between the template and the first frame. The third block may correspond to the predicted block 930.

In operation S1150, a fourth block of the second frame may be decoded based on the third block. The fourth block may correspond to the current block 870. The first block may correspond to an adjacent block of the fourth block.

Technical descriptions according to exemplary embodiments of the present invention described with reference to FIG. 1 through FIG. 10 may be applied to the present exemplary embodiment. Thus, further descriptions will be omitted for conciseness.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

[

### Explanation of Reference Numerals]

810: template using an intra-prediction

1000: apparatus for motion estimation

What is claimed is:

1. A template used for a video decoding, the template comprising:
an adjacent block template including at least one decoded block, adjacent to a current block to be decoded, in a decoded area in a current frame; and
a predicted block template generated based on a predicted location,
wherein the predicted location is generated by applying an intra-prediction to the at least one decoded block.

2. The template of claim 1, wherein a size of the adjacent block is changed depending on a size of the current block.

3. The template of claim 1, wherein a directionality of the intra-prediction is limited based on a size of the current block.

4. The template of claim 3, wherein the intra-prediction has nine directionalities when the size of the current block is less than or equal to a predetermined size, and the intra-prediction has four directionalities when the size of the current block is greater than the predetermined size.

5. The template of claim 1, wherein a directionality of the intra-prediction is limited based on a shape of the current block.

6. The template of claim 5, wherein the directionality of the intra-prediction is limited based on whether the current block corresponds to a square shape or a rectangular shape.

7. The template of claim 1, wherein directionality information of the at least one decoded block is included in a bit stream that has the current frame.

8. An apparatus for motion estimation used for a video decoding, the apparatus comprising:
a template generator to generate a template including directionality prediction information of a current block to be decoded; and
an optimal location retrieving unit to retrieve an optimal location of a predicted block by performing a template matching between the generated template and a previously decoded frame,
wherein the template matching uses the directionality prediction information.

9. The apparatus of claim 8, wherein:
the template comprises:
an adjacent block template including at least one decoded block, adjacent to the current block, in a decoded area in a current frame; and
a predicted block template generated based on a predicted location, and
the predicted location is generated by applying an intra-prediction to the at least one decoded block.

10. The apparatus of claim 9, wherein the template matching corresponds to a weighted sum of a template matching using the adjacent block template and a template matching using the predicted block template.

11. The apparatus of claim 10, a weight used for the weighted sum is included in syntax information of the current frame, and is transmitted.

12. The apparatus of claim 8, wherein the template matching is performed based on at least one of a sum of absolute difference (SAD) or a sum of squared difference (SSD).

13. The apparatus of claim 12, wherein the syntax information of the current frame includes information indicating whether to use the SAD or the SSD to perform the template matching.

14. A method for motion estimation used for a video decoding, the method comprising:
decoding a first frame;
decoding a first block of a second frame;
generating a template based on the first block and a second block that is generated by applying an intra-prediction to the first block;
determining a third block based on a template matching between the template and the first frame; and
decoding a fourth block of the second frame based on the third block.

15. The method of claim 14, wherein the template includes a first template part generated based on the first block and a second template part generated by applying an intra-prediction to the first block.

16. The method of claim 15, wherein the template matching corresponds to a weighted sum of a template matching using the first template part and a template matching using the second template part.

17. The method of claim 14, wherein the first frame corresponds to a frame preceding the second frame, temporally, in the corresponding video.

18. The method of claim 14, wherein the template matching uses at least one of a sum of absolute difference (SAD) or a sum of squared difference (SSD).
